(19) United States
(12) Patent Application Publication
(10) Pub. No.: US 2015/0206087 A1
(43) Pub. Date: Jul. 23, 2015

(54) Synchronous Location-Based Matching of Merchant Offers with High Propensity Consumers

(71) Applicant: VSK Ventures, LLC, San Mateo, CA (US)

(72) Inventor: Silvio Tavares, San Mateo, CA (US)

(73) Assignee: VSK Ventures, LLC, San Mateo, CA (US)

(21) Appl. No.: 14/157,643

(22) Filed: Jan. 17, 2014

(51) Int. Cl. G06Q 10/06

(52) U.S. Cl. CPC G06Q 10/06393

(57) ABSTRACT

Novel tools and techniques that can optimize the ability of a merchant's to balance pricing and offer strategies based on a real-time analysis of the merchant's performance relative to similar merchants (e.g., merchants selling similar products and/or merchants in a similar location) and/or match such strategies with a real-time assessment of consumers that have a high propensity to respond to such advertising. In one aspect, certain tools can employ data analytics tools to support these functions, for example, to determine relative performance of a merchant and/or to identify customers with a high propensity to purchase from the merchant. In another aspect, certain tools can employ feedback techniques to adjust or fine-tune the advertising strategy.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to the field of data analytics and more particularly, to tools and techniques for matching merchant offers with consumers based on such data analytics.

### BACKGROUND

In the field of marketing, the use of targeted advertising is well known. Perhaps the simplest example of such a phenomenon is a merchant's practice of sending offers to existing or past customers. More recently, technology such as search engines, browser cookies, location services, and the like have enabled further targeting efforts, allowing merchants to target offers to consumers who might not be past customers but who might still be more likely than average to be future customers.

For example, a merchant might use location services to identify consumers in the immediate vicinity of the merchant's location and target advertising messages to those consumers, on the theory that consumers near the merchant's location would be more likely to respond to such offers then consumers distant from the merchant's location. Other examples abound, including the use of consumers online interests and tendencies to develop profiles that can be used to target advertising to those consumers. Still, however, such targeted advertising strategies into act as a relatively blunt instrument because the tools for profiling consumers often use imprecise proxies to estimate consumer's interest in particular types of products.

At the same time, the rise of big data has enabled analytical tools that would have been impossible in the past. Merely by way of example, the availability of transaction data can inform businesses of sales trends, business performance, generalized consumer behavior, and many other analytics that can drive sales and improve profitability. The availability of such data, and the sophistication of the tools for its analysis, continue to advance at an increasing rate.

To date, however, there exist few tools to enable the use of data analytics to provide precise matching between a consumer's location and/or propensity to buy a product and a merchant's need and/or available supply to sell that particular product. In particular, no tools exist that can provide real-time evaluation of merchant sales performance and matching of offers to consumers with a high propensity to respond positively to those offers in physical proximity to the merchant.

### BRIEF SUMMARY

A set of embodiments provides tools and techniques that can optimize the ability of a merchant to balance pricing and offer strategies based on a real-time analysis of the merchant's performance relative to similar merchants (e.g., merchants selling similar products and/or merchants in a similar location) and/or match such strategies with a real-time assessment of consumers that have a high propensity to respond to such advertising in the nearby vicinity of the merchant. In one aspect, certain embodiments can employ data analytics tools to support these functions, for example, to determine relative performance of a merchant and/or to identify customers with a high propensity to purchase from the merchant. In yet another aspect, certain embodiments can employ feedback techniques to adjust or fine-tune the advertising and/or offer pricing strategy.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible and/or non-transitory computer readable media (such as, to name but a few examples, optical media, magnetic media, and/or the like).

Merely by way of example, a method in accordance with one set of embodiments might comprise creating, e.g., in a database, a merchant enrollment record for a merchant. In an aspect the creation of the enrollment record might be based on a request from the merchant to enroll in a service. In another aspect, the merchant enrollment record might comprise a number of fields or data elements, which can include, without limitation, one or more of the following: a physical sales location of the merchant, an identifier of the merchant, a classification of the merchant, an average transaction value of purchases from the merchant, opening and closing hours of the merchant, and/or an identifier of a payment processor of the merchant. In some cases, the classification of the merchant might be a Standard Industrial Classification (“SIC”) code assigned to the merchant, a free text description of the merchant's type and/or products sold by the merchant, etc.

The method, in some embodiments, might further comprise creating, e.g., in a database (which might be the same or a different database), consumer enrollment records for a plurality of consumers. Such creation might be based on a request from each of the plurality of consumers to enroll in the service. In some cases, each consumer enrollment record might comprise one or more fields or data elements, including without limitation one or more of the following: payment card information, contact information, and/or geolocation information (which might indicate, for example, how to determine a current location of a customer at a given time). Contact information can include, merely by way of example, one or more wireless phone numbers, one or more email addresses, and/or a user identifier in a mobile application or social media service. Geolocation information can include, without limitation, a wireless phone number, a car registration, an Internet Protocol address, and a Media Access Control (“MAC”) address, and in some cases, can be used to determine a current location of a consumer, e.g., by obtaining global navigation satellite system (“GNSS”) data based on the geolocation information.

A number of techniques can be used to populate such records. For instance, the computer might receive merchant or consumer enrollment information from the merchant or consumer via a user interface, such as a telephone call, web site, or mobile application, to name a few examples. In some cases, the method might comprise receiving consumer enrollment data from a card issuer of payment cards issued to one or more of the plurality of customers.

The method can further comprise storing, in a database (which can be the same database or a different database), transaction data of each of the plurality of consumers and/or obtaining, with a computer, real-time sales data of the merchant; in some cases, the identifier of the payment processor of the merchant can be used to determine how to obtain the real-time sales data (e.g., from what source to obtain the data). The method can further comprise aggregating, with the computer, transaction data over a specified period for a plurality of merchants and/or calculating, with the computer and from the aggregated transaction data, unit sales for a geographical area of the merchant and the classification of the merchant. A variety of techniques can be used to calculate unit sales; for example, calculating unit sales might comprise calculating, perhaps in real time, a total value of retail payment transactions for the geographical area and/or a total growth rate of retail payment transactions for the geographical area, and/or comparing a total of value of retail payment transactions for a current period with a total value of retail payment transactions for a prior period, to name a few examples. The method can also include identifying, with the computer, performance of the merchant relative to the unit sales. Based, for example, on the calculated unit sales, the method can comprise determining (in some cases, in real time) with the computer, that the merchant is underperforming compared to similar merchants in the geographical area.

The method can further include determining, with the computer, a propensity of each of one or more consumers to buy products from the merchant; in some cases, this determination might be based at least in part on a current location of each of the one or more consumers and/or historical transaction data of each of the one or more customers. The computer might provide an alert to the merchant; the alert, in some embodiments, can indicate that the merchant is underperforming and/or can identify a number of potential customers within a specified perimeter of the physical sales location of the merchant with a demonstrated propensity to buy products from providers within the classification of the merchant.

In some cases, the method can include communicating, from the computer and to each of the one or more consumers with a determined propensity to buy products from the merchant, an advertising message comprising an offer to buy one or more products from the merchant. (In some cases, communicating such a message might comprise communicating the message directly from the computer to consumer devices or the like; in other cases, communicating such a message might comprise the computer providing data, such as consumer contact information and/or a message template, to a merchant to allow the merchant to communicate directly with the consumer(s).) Any number of techniques can be used to communicate a message, including without limitation electronic mail or text message, communicating an advertising message through a mobile application on a wireless device of a user, and/or the like.

In some cases, the method might include feedback techniques to adjust the messaging operations. Merely by way of example, in some cases, the method might comprise detecting, with the computer, a vector of movement of one of the consumers to whom the offer was communicated. Based on a determination that the vector of movement is approaching the physical sales location of the merchant, the method might comprise communicating one or more additional advertising messages to the one of the consumers. Alternatively and/or additionally, the method might include comparing, with the computer, a number and type of transmitted advertising messages with an increase in volume of sales of the merchant. In turn, the method might comprise modulating, with the computer, a number and type of advertising messages transmitted to the one or more customers until performance of the merchant reaches a determined threshold, and/or discontinuing, with the computer, transmission of advertising messages when the performance of the merchant reaches the determined threshold.

A variety of different thresholds (relative and/or absolute) are possible in various embodiments. For example, one threshold might comprise equilibrium (e.g., to within a desired precision or threshold variance) between performance of the merchant and performance of similar merchants. Alternatively and/or additionally, a threshold might comprise an amount of sales (either absolute or relative to a prior sales amount).

A method in accordance with another set of embodiments comprises creating a merchant enrollment record for a merchant and/or consumer enrollment records for a plurality of consumers. These records might be created in one or more databases. The method can further include storing (e.g., in one or more databases) transaction data of each of the plurality of consumers. In some cases, the method comprises obtaining, with a computer, real-time sales data of the merchant; determining, with the computer, that the merchant is underperforming compared to similar merchants in the geographical area; and/or determining, with the computer, a propensity of each of one or more consumers to buy products from the merchant. In some embodiments, one or both of these determinations can be made in real time. The determination of a consumer's propensity to buy products might be based at least in part on a current location of each of the one or more consumers and/or historical transaction data of each of the one or more customers. In some cases, the method can comprise communicating, to each of to each of the one or more consumers with a determined propensity to buy products from the merchant, an advertising message comprising an offer to buy one or more products from the merchant. Such communication might be sent directly from the computer or might be sent from the merchant itself, among other options.

An apparatus provided by another set of embodiments might comprise a non-transitory computer readable medium having encoded thereon a set of instructions executable by one or more computers to perform one or more operations, including without limitation operations provided by methods in accordance with various embodiments. Merely by way of example, in some cases, the set of instructions might comprise instructions to create, in a database, a merchant enrollment record for a merchant; instructions to create, in the database, consumer enrollment records for a plurality of consumers; instructions to store, in the database, transaction data of each of the plurality of consumers; instructions to obtain real-time sales data of the merchant; instructions to determine that the merchant is underperforming compared to similar merchants in the geographical area; instructions to determine, in real time, a propensity of each of one or more consumers to buy products from the merchant, based at least in part on a current location of each of the one or more consumers and historical transaction data of each of the one or more customers; and/or instructions to communicate, to each of the one or more consumers with a determined propensity to buy products from the merchant, an advertising message comprising an offer to buy one or more products from the merchant. Other embodiments might include more, fewer, or different instructions.

Similarly, a computer system in accordance with a set of embodiments might comprise one or more processors and a computer readable medium in communication with the one or more processors. In an aspect, the computer readable medium might have encoded thereon a set of instructions executable by the computer system to perform one or more operations, including without limitation operations provided by methods in accordance with various embodiments. Merely by way of example, in some cases, the set of instructions might comprise instructions to create, in a database, a merchant enrollment record for a merchant; instructions to create, in the database, consumer enrollment records for a plurality of consumers; instructions to store, in the database, transaction data of each of the plurality of consumers; instructions to obtain real-time sales data of the merchant; instructions to determine that the merchant is underperforming compared to similar merchants in the geographical area; instructions to determine, in real time, a propensity of each of one or more consumers to buy products from the merchant, based at least in part on a current location of each of the one or more consumers and historical transaction data of each of the one or more customers; and/or instructions to communicate, to each of the one or more consumers with a determined propensity to buy products from the merchant, an advertising message comprising an offer to buy one or more products from the merchant. Other embodiments might include more, fewer, or different instructions.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIGS. 1A and 1B are block diagrams illustrating systems for matching merchant offers with high-propensity customers, in accordance with various embodiments.

FIGS. 2-4 illustrate exemplary database records, in accordance with various embodiments.

FIG. 5 is a process flow diagram illustrating a method of enrolling merchants and consumers and of determining merchant underperformance, in accordance with various embodiments.

FIG. 6 is a process flow diagram illustrating a method of identifying merchant performance, in accordance with various embodiments.

FIG. 7 is a process flow diagram illustrating various techniques for calculating unit sales for a class of merchants, in accordance with various embodiments.

FIG. 8 is a process flow diagram illustrating a method of matching an advertising strategy with high-propensity consumers, in accordance with various embodiments.

FIG. 9 is a process flow diagram illustrating a method of adjusting messaging communications according to consumer movement, in accordance with various embodiments.

FIG. 10 is a process flow diagram illustrating a method of adjusting messaging communications according to a comparison between sales and a specified threshold.

FIG. 11 is a generalized schematic diagram illustrating a computer system, in accordance with various embodiments.

FIG. 12 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

A set of embodiments provides tools and techniques that can optimize the ability of a merchant to balance pricing and offer strategies based on a real-time analysis of the merchant's performance relative to similar merchants (e.g., merchants selling similar products and/or merchants in a similar location). (As used herein, the terms “real-time” and “real time” should be interpreted to include near-real-time determinations, which are based on the most current available data. Due to the nature of transaction processing, there can be marginal delays in the transmission of transaction data between, e.g., a payment processor and the systems described herein, and the terms “real-time” and “real time,” as used herein, should be understood to include processing that is delayed slightly to reflect such transmission delays.) In an aspect, such tools can provide real-time visibility into a merchant's relative performance against the market (e.g., underperformance or overperformance) and can develop an advertising strategy accordingly. In another aspect, some embodiments can match that advertising strategy with a real-time assessment of consumers that have a high propensity to respond to such advertising.

One way in which these functions can be accomplished is through the use of data analytics tools. Merely by way of example, through the use of historical transaction records, tools provided by certain embodiments can calculate unit sales for similar merchants over any desired period and can assess a particular merchant's performance against those unit sales. If the merchant proves to be underperforming, for example, the tools can create a pricing and/or advertising strategy (e.g., determining discounts, special pricing, or other offers, and/or communicating certain advertising messages—perhaps including the discounts, pricing, offers, etc.—to specified consumers in a specified fashion). As used herein, the term “advertising message” (and derivatives thereof, such as “advertising messaging”) is used to describe any type of promotional messaging that can be sent from (or on behalf of) a merchant to one or more consumers. Examples of advertising messages can include, without limitation, offer messages (which might offer a specific product at a specific price), advertisements (which promote one or more products, or the merchant generally, without a particular offer), discount messages (which might offer a discount on specific products or a general discount on some or all of the merchant's products) loyalty messages (which can provide discounts or savings based on a consumer's prior purchases), and/or the like. Such messages can be communicated using any suitable medium, including by way of example (and without limitation), short message service (“SMS”) messages, text messages, electronic mail messages, messages provided through an interface on an app installed on a mobile device, voice messages, web pages (including links provided in any other medium described herein that refer to such web pages), and/or the like.

As another example, some embodiments can use data analytics to determine which consumers have a high propensity to respond to the offer messages (or other advertising vehicles determined by the strategy) and can communicate the messages to those consumers. Merely by way of example, a consumer's purchase history (possibly including the locations of such purchases) and the consumer's current location can be matched against the merchant's profile (e.g., location and type of product sold) to identify the optimal consumers to whom the messages should be communicated. (As used herein, the term “product” refers to any good or service that can be sold or otherwise provided by a merchant and/or purchased by a consumer.)

In another aspect, certain embodiments employ feedback techniques to adjust or fine-tune the advertising and/or pricing strategy. One example of such a technique is to observe the locational behavior of a consumer after receiving such a message, and send follow up messages accordingly. For instance, if a vector of the consumer's movement is away from the merchant's location, the system might transmit a different type of message (e.g., a more attractive offer) to entice the consumer to turn back toward the merchant. Alternatively, if the vector of movement is toward the merchant's location, the system might send encouraging messages, directions to the merchant's location, and/or the like.

Another type of feedback look that can be employed by certain embodiments is the ability to adjust a messaging campaign based on a real-time comparison against a sales threshold. For example, as sales increase (likely as a result of the messaging), the offer messages might be modified to include less aggressive offers. At the point at which the merchant's sales reach the threshold (which can be defined in different ways, as described below, including without limitation a threshold relative to other merchants' sales performance), the system might stop communicating messages to customers.

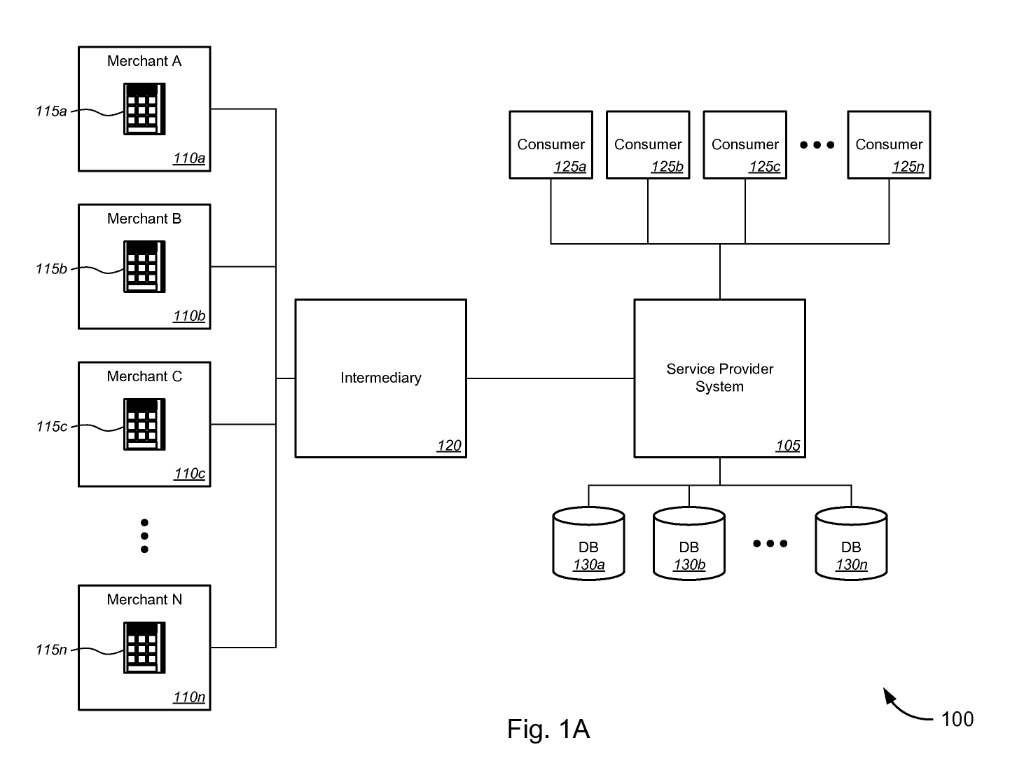

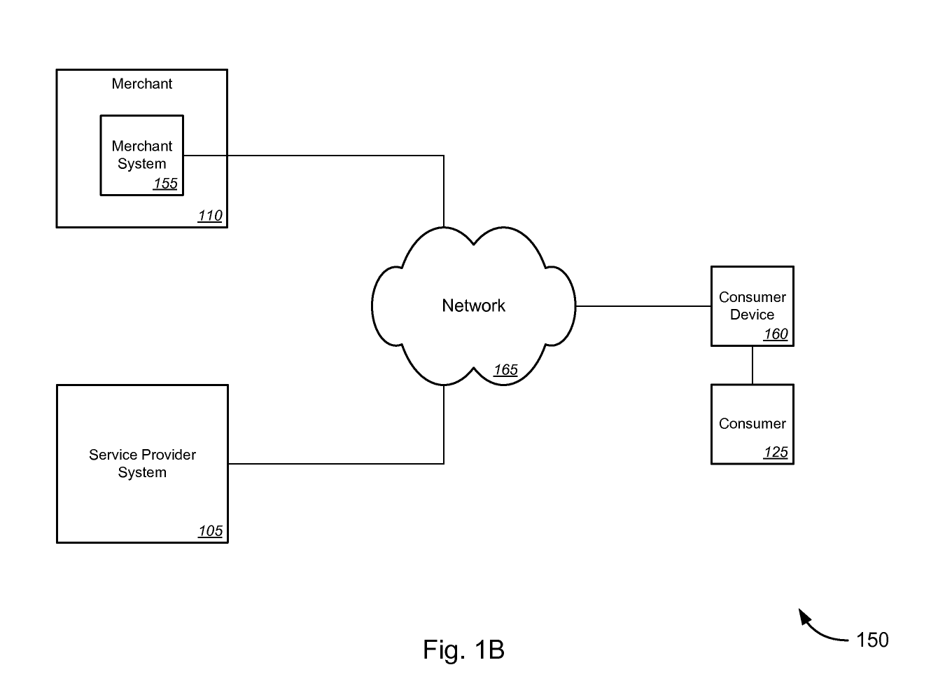

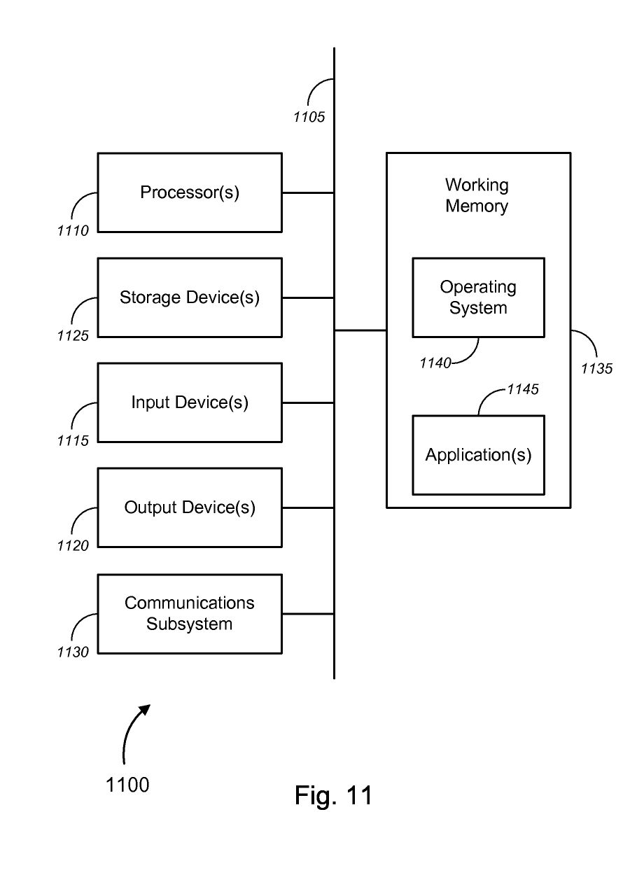

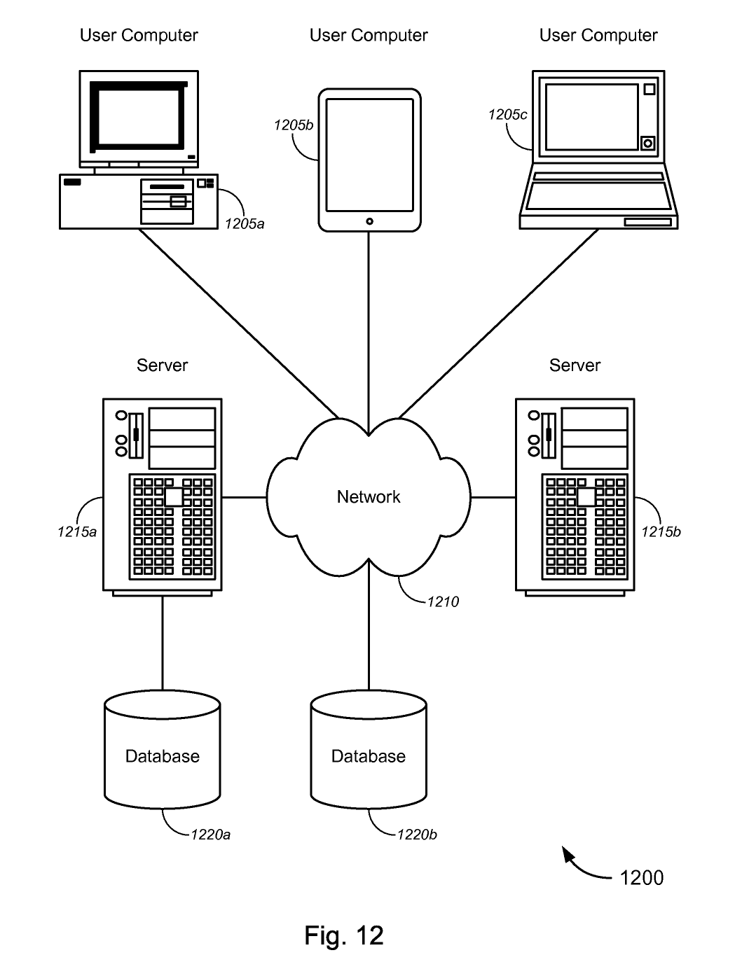

The figures illustrate additional details of various embodiments. For example, FIG. 1A is a block diagram illustrating a system 100 for matching merchant offers with high-propensity customers, in accordance with various embodiments. The system 100 includes a service provider system 105, which is operated by a provider of the offer matching services described herein. Such a provider might be a provider of other services as well, such as a payment card network, payment card processor, bank or another financial institution, advertising agency, and/or the like. (As used herein, the term “payment card” means any type of card that can be used to purchase products, such as a credit card, debit card, stored value card, and/or the like. Such cards may be generically referred to herein as “credit cards,” but such references should be understood to apply to all types of payment cards.) Alternatively, such a provider might be a third-party that can interface with merchants 110 and/or any of the above service providers. The service provider system 105 can be a mainframe or server computer, or any other computer capable of performing the functions described in further detail below. Exemplary architectures for such computers are described below with regard to FIGS. 11 and 12.

In some embodiments, the service provider system 105 collects transaction data about a plurality of merchants (e.g., merchants 110). A variety of different techniques can be used to obtain this transaction data. Merely by way of example, in some cases, when a particular merchant 110a submits a sales transaction through a point-of-sale device 115a, an intermediary 120, such as a payment card network, card processor, and/or the like will process the transaction in a conventional fashion. The service provider system 105, then, might collect transactions (e.g., in batch uploads, as individual transactions, etc.) from such an intermediary 120. Alternatively and/or additionally, the service provider system 105 might obtain transaction data directly from a merchant 110a, either through the point-of-sale device 115a or otherwise. Based on the disclosure herein, the skilled reader will appreciate that there are a variety of ways for the service provider system 105 to obtain transaction data, and any suitable technique can be used in accordance with various embodiments.

As described in further detail below, the service provider system 105 might enroll one or more merchants 110 and/or one or more consumers 125 in the offer matching service. By enrolling in the service, a merchant 110 can participate in the evaluation of its performance and/or the offer matching techniques described below. Conversely, a consumer 125 might enroll in the service in order to receive offers that the consumer has a high propensity of accepting.

The service provider system 105 can include, and/or can be in communication with, one or more databases 130, which can store transaction data, enrollment data, location data, and many other types of data is described in further detail below. The organization of such databases 130 is discretionary. Merely by way of example, a single database 130a might comprise multiple tables (which might be relationally linked, might be flat tables, etc.), including without limitation a transaction table, which might include transaction records generated from the collective transaction data, a merchant table, which might include merchant enrollment data for merchants who have enrolled in the service, and/or customer table, which might include data of consumers who have enrolled in the service. Alternatively, the system 100 may include a separate database 130 for each of these different types of data. The structure and organization of the database(s) 130 is discretionary and can vary depending on the embodiment.

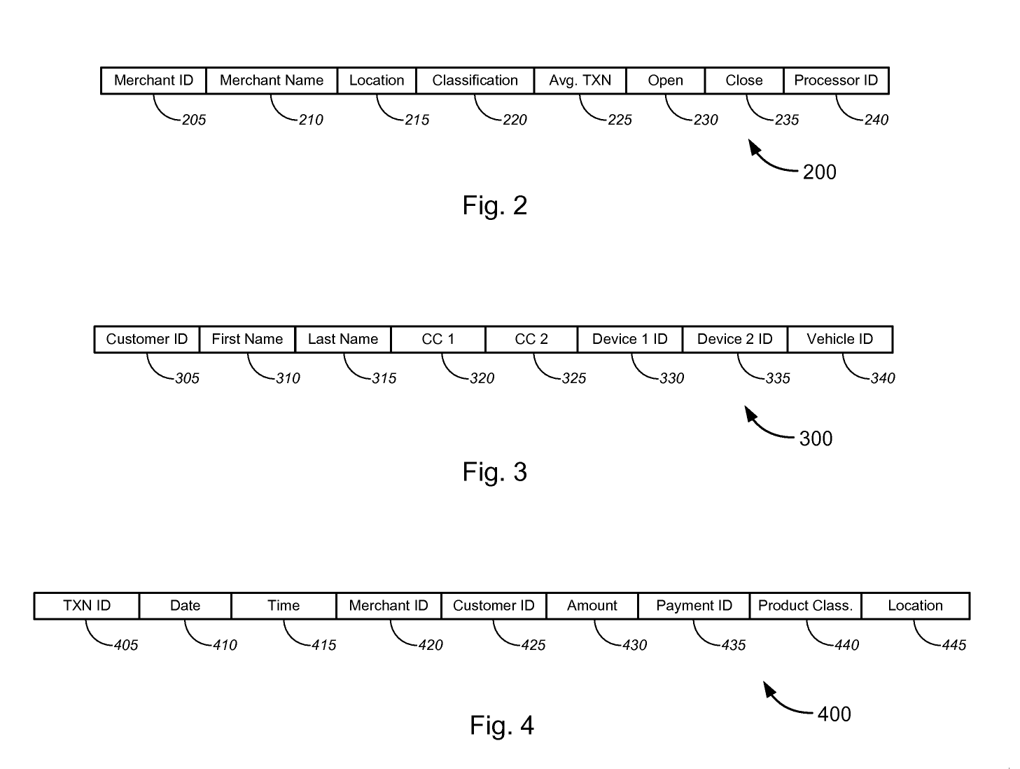

Examples of various records that can be stored in the database(s) 130, irrespective of the organization of those database(s), are illustrated by FIGS. 2-4. (It should be noted, of course, that these examples are provided for purposes of illustration and are not intended to be limiting in any respect.)

For example, FIG. 2 illustrates a merchant enrollment record 200, one of which can be created for each merchant 110 that enrolls in the service. The enrollment record 200 might include a merchant identifier 205, which can be a unique identifier within the service provider system 105 to identify the merchant to the system 105, and a merchant name 210. The record 200 might also include a field 215 identifying a physical location of the merchant; this physical location can be expressed in any suitable fashion, including without limitation, street address, latitude/longitude coordinates, and/or the like. (In this respect, a merchant with multiple locations might enroll each location separately, and/or a discrete enrollment record might be created for each location. As such, each location for a multiple-location merchant might be treated by the provider system 105 as a separate merchant for some purposes.)

The enrollment record 200 can also include other data about the merchant, such as a field 220 indicating a classification of the merchant, which might be a Standard Industrial Classification (“SIC”) code assigned to the merchant, free-form text describing the merchant and/or products the merchant provides, and/or the like. Other data stored in the enrollment record can include a field 225 indicating an average amount of transactions performed by the merchant, fields 230-235 indicating opening and/or closing hours of the merchant, and/or a field 240 identifying a payment processor used by the merchant (which can be used to obtain real-time sales data about the merchant's transactions, as described below).

FIG. 3 illustrates an exemplary consumer enrollment record 300, one of which can be created for each consumer who enrolls in the service. The consumer enrollment record 300 might include a customer identifier 305, which might uniquely identify the customer within the provider system 105, and fields 310-315 for the first and/or last name of the consumer. The record 300 might further include one or more fields 320-325 to store identifiers of payment methods (e.g., as illustrated, credit card numbers, and/or, alternatively, routing/account numbers of checking accounts, account information for online payment methods such as PayPal™, and/or the like).

In some cases, the record can also include geolocation information for the customer. Such geolocation information can include identifiers for mobile devices (e.g., phones, tablet computers, etc.), as shown in fields 330-335 and/or vehicle identifiers 340 (which can allow geolocation through vehicle locator services, such as OnStar™ or the like). It should be noted that the device identifiers (which can include phone numbers, Internet Protocol (“IP”) addresses, media access control (“MAC”) addresses, International Mobile Station Equipment Identity (“IMEI”) numbers, subscriber identity module (“SIM”) identifiers, and the like) can be used both to identify a consumer's location (though location of the device) and as an address to which messages can be sent, as noted further below. The record 300 might also include other contact information, such email addresses, phone numbers, user IDs (e.g., for a mobile application provided by the service provider, for social networking services that might be used to access the offer matching service, etc.) home addresses, and the like (which can be stored as device identifiers and/or in separate fields, not shown on FIG. 3).

FIG. 4 illustrates a transaction record 400, which can be created for each transaction about which data is collected. As noted below, there are a variety of ways in which such data can be collected, but the record 400 (or a similar record) can be generated from the data regardless of how that data is collected. The exemplary record 400 might comprise a transaction identifier 405, which can be part of the data received about the transaction (e.g., an authorization number or a transaction identifier assigned by a payment processor) or the transaction identifier 405 might be a unique identifier assigned by the provider system 105. In some cases, the record 400 might comprise multiple transaction identifiers (e.g., one received as part of the data about the transaction and one generated by the system 105). In other cases, the system 105 might merely adopt an identifier received with the data as the identifier to be used by the system 105.

The transaction record 400 might further comprise fields 410-415 indicating a date and time, respectively of the transaction, as well as fields 420-425 identifying the merchant and the customer, respectively, that participated in the transaction. There might also be a field 430 populated with the amount of the transaction and/or a field 435 identifying the payment method (e.g., a credit card number, etc.). There may be a field 440 indicating a merchant and/or product classification of product purchased as part of the transaction and/or a field 445 indicating a physical location (which can be, e.g., a street address, latitude/longitude coordinates, etc.) of the merchant that engaged in the transaction.

Some or all of the data to populate these fields can be obtained from the transaction data received by the provider system 105; alternatively and/or additionally, some of the fields might be populated with data obtained from other sources and/or derived by the system 105 itself. For example, the merchant identifier (field 420) and/or customer identifier (field 425) might be populated with values (e.g., system-unique identifiers, such as the identifiers in fields 205, 305 described above) that are derived based on information (e.g., customer name, merchant name) received as part of the transaction data. (Alternatively and/or additionally, the names obtained from the raw data might be used to populate these fields.) Similarly, in some cases, the system 105 might receive merchant location information with the transaction data feed, in which case that field 445 can be populated with such information. In other cases, however, the system 105 might maintain (e.g., in a separate database table) a correlation between merchants and physical locations, and the location field 445 might be populated based on a lookup of the merchant name (or other identifier) against that correlation data.

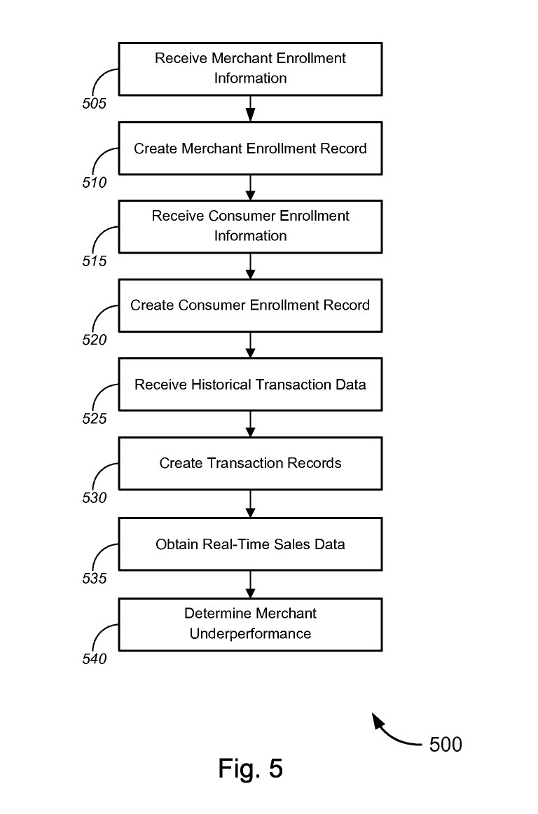

Returning to FIG. 1A, then, the service provider system 105 can collect transaction data (e.g., from an intermediary 210), enroll merchants 115 and consumers 125, store the transaction and enrollment data in one or more databases 130, and use this data to provide offer matching services. Various methodologies for providing these services are described in further detail with regard to FIGS. 5-10 below.

In general, however, an exemplary system according to one embodiment might enroll a merchant 115a and its location, e.g., via the web, mobile or telephone, (along with the merchant's real time sales data, e.g., from an intermediary 120, such as a payment processor) into a system 105 that provides the service described herein. FIG. 1B illustrates the operation of a system 150 (which can be considered, in some aspects, a different view of the system 100 of FIG. 1A) with regard to a particular merchant 110 and consumer 125.

As shown in FIG. 1B, the service provider system 105 might be in communication with a merchant system 155 and/or a consumer device 160 over a network 165. Examples of such systems, devices and networks are described in detail below with regard to FIGS. 11 and 12, but generally, the network 165 can be any network (or combination of networks) that provides the necessary connectivity between the respective devices. The consumer device 160 might be any type of user computer described below, including specifically but without limitation, a mobile device, personal computer, vehicle location system, etc.). The merchant system 155 might be a point-of-sale device 115, and/or it might be a separate computer, such as the user computers and servers described below with regard to FIG. 12. The service provider system 105 communicates with the merchant system 155 and/or the consumer device 160 to accomplish the offer matching services described in further detail below.

The provider system 105 uses business rules to benchmark underperforming and overperforming merchants within a rules-based geographic unit. The system 105 compiles the present location of specific consumers within that same geographic unit by means of payment location information or GPS data provided from the consumer's wireless device or car.

In this exemplary system, for the consumers (e.g., the consumer 125) located in that certain geographic unit (which might be a ZIP code, a radius from a particular merchant, an area defined by sets of cross streets or intersections, etc.), a propensity to buy certain goods from specific merchant categories (e.g., a category of the merchant 110) is calculated by interrogating the consumer's 125 historical transactions and executing an algorithm. For a consumer 125 exhibiting a certain purchasing propensity above a certain rules based threshold, an advertising message (e.g., advertisement, offer, or discount message) is triggered from (or on behalf of) the underperforming merchants (e.g., the merchant 125) in that same geographic unit. A vector of the consumer's 125 change in location is determined, and for vectors that increasingly approximate the selected merchant's 110 location, additional advertising messages are sent via text, email and/or mobile application. The number of and type of transmitted messages is compared to the increase in volume of a specific merchant's 125 sales, and the advertisement messages are modulated until the merchant 125 reaches equilibrium with similar merchants (e.g., merchants with similar classifications and/or in a similar geographic area) or predetermined sales benchmark. At that point, the advertising messages are discontinued. It should be noted, of course, that while FIG. 1B illustrates this technique with a single merchant 110 and consumer 125, embodiments can employ the same techniques simultaneously with a plurality of merchants and/or consumers in a particular geographic area or multiple geographic areas simultaneously.

FIGS. 5-10 illustrate various methods that can be used to provide offer-matching services for merchants and consumers. While the methods of FIGS. 5-10 are illustrated, for ease of description, as different methods, it should be appreciated that the various techniques and procedures of these methods can be combined in any suitable fashion, and that, in some embodiments, the methods depicted by FIGS. 5-10 can be considered interoperable and/or as portions of a single method. Similarly, while the techniques and procedures are depicted and/or described in a certain order for purposes of illustration, it should be appreciated that certain procedures may be reordered and/or omitted within the scope of various embodiments. Moreover, while the methods illustrated by FIGS. 5-10 can be implemented by (and, in some cases, are described below with respect to) the systems 100 and 150 of FIGS. 1A and 1B (or components thereof, such as the processor system 105), these methods may also be implemented using any suitable hardware implementation. Similarly, while the systems 100 and 150 of FIGS. 1A and 1B (and/or components thereof) can operate according to the methods illustrated by FIGS. 5-10 (e.g., by executing instructions embodied on a computer readable medium), the systems 100 and 150 can also operate according to other modes of operation and/or perform other suitable procedures.

For example, FIG. 5 is a process flow diagram illustrating a method 500 of enrolling merchants and consumers and of determining merchant underperformance, in accordance with various embodiments. The method 500 comprises receiving merchant enrollment information (block 505). The enrollment information can comprise some or all of the information necessary to perform the services described herein (and/or, in particular, the information to populate a merchant enrollment record). There are a variety of ways in which the provider system can receive merchant enrollment information. For example, the merchant might access a user interface provided by the system to enroll (and thereby provide the appropriate merchant enrollment information).

Such a user interface can take many forms. For example, the user interface can be used to output information for a user, e.g., by displaying the information on a display device, printing information with a printer, playing audio through a speaker, etc.; the user interface can also function to receive input from a user, e.g., using standard input devices such as mice and other pointing devices, motion capture devices, touchpads and/or touchscreens, keyboards (e.g., numeric and/or alphabetic), microphones, etc. The procedures undertaken to provide a user interface, therefore, can vary depending on the nature of the implementation; in some cases, providing a user interface can comprise displaying the user interface on a display device; in other cases, however, in which the user interface is displayed on a device remote from the computer system (such as on a client computer, wireless device, etc.), providing the user interface might comprise formatting data for transmission to such a device and/or transmitting, receiving and/or interpreting data that is used to create the user interface on the remote device; for example, the user interface might be displayed by an app on a mobile device, and providing the user interface can comprise providing the app for the device, sending data to the app for display to the user, receiving data from the app, and/or the like.

Alternatively and/or additionally, the user interface on a client computer (or any other appropriate user device) might be a web interface, in which the user interface is provided through one or more web pages that are served from a computer system (and/or a web server in communication with the computer system), and are received and displayed by a web browser on the client computer (or other capable user device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic HTML and/or AJAX technologies, to name but a few examples.

The reader should appreciate, therefore, that a variety of different user interfaces can be used to interact with various system users (e.g., merchants, consumers, etc.) As other examples of possible user interfaces, the provider system might provide a user interface over the telephone (e.g., using an integrated voice response (“IVR”) system or human operators), though an electronic mail address, and/or the like. In some cases, the provider system might provide a user interface through a merchant's point-of-sale device, which can be used to gather merchant enrollment information and/or provide other interaction between the provider system and the merchant (either through an intermediary such as a payment processor or directly). In particular embodiments, a social network that provides federated sign-on services might serve as a user interface, allowing a user (whether a merchant or a consumer) to sign on to the provider system and/or to interact with the provider system using the social network service's facilities.

As noted above, in an aspect of certain embodiments, the user interface provides interaction between a user and a computer system. Hence, when this document describes procedures for displaying (or otherwise providing) information to a user, or to receiving input from a user, any such user interface (or a combination of multiple user interfaces) can serve as the vehicle for the exchange of such input/output. Merely by way of example, any of such user interfaces described above can be used to receive enrollment information from a merchant.

Alternatively, the provider system might receive enrollment information from another source. For example, a merchant's business network provider, payment processor, or other intermediary might provide the enrollment information (perhaps at the request of the merchant or as a value added service to the merchant). In any event, however the merchants' enrollment information is received, the method 500 can include creating an enrollment record for the merchant (block 510), e.g., in a database. An example of such an enrollment record, including examples of data that might be included in an enrollment record, is described above with regard to FIG. 2, although the skilled reader should understand that other embodiments might employ different formats and/or store different information in the enrollment record.

At block 515, the method 500 can include receiving consumer enrollment information for one or more consumers. Such information can be received from a consumer directly, e.g., through a user interface such as one of those described above. Alternatively and/or additionally, a third party might provide the enrollment information on behalf of the consumer. For example, a consumer's credit card issuer, bank, or other financial institution might provide enrollment information to the provider system, perhaps at the request of the consumer and/or using an opt-in or opt-out system for a large number of consumers.

Like the merchant's enrollment information, a consumer's enrollment information might comprise some or all of the information necessary for the provider to provide the offer matching services, and/or the information to populate a consumer enrollment record. As such, the method 500 can further include, at block 520, creating a consumer enrollment record for each consumer that enrolls in the service, based on the received consumer enrollment information. An example of such a consumer enrollment record, including examples of data that might be included in the enrollment record, is described above with regard to FIG. 3, although the skilled reader should understand that other embodiments might employ different formats and/or store different information in the enrollment record.

At block 525, the method comprises receiving (e.g., at the provider system) historical transaction data. As noted above, such transaction data can be received from a variety of sources, including intermediaries such as payment processors, card networks, card issuers, banks and other financial institutions, etc. In other cases, transaction data can be received from merchants themselves (e.g., from a merchant's financial system, from a merchant's point-of-sale device, etc.). The technique for receiving the data can vary as well. Merely by way of example, the provider system might receive transaction data as a stream of individual transaction messages, as transactions occur. Alternatively and/or additionally, the provider system might receive transaction data in batch format, e.g. as periodic data files from a payment processor, which might be provided in a standard or proprietary format (e.g., a plaintext file, an XML file, and/or the like) on an interval agreed between the provider and the intermediary that supplies the transaction data.

The method 500, then, can include creating transaction records for some or all of the transactions reflected in the transaction data received by the provider system (block 530). The transaction data might include some or all of the information to populate a transaction record for each transaction. Merely by way of example, as noted above, an exemplary transaction record illustrated by FIG. 4 might include a merchant identifier, a customer identifier, and/or a location identifier. The received transaction data might include each of these data elements, but in some cases it might not. For instance, the transaction data might include a customer name and credit card number, and the combination of these data elements could be used by the provider system to look up a consumer identifier that is unique within the provider system. Similarly, the merchant name and location may be provided in the transaction data, and this information could be used to look up a merchant identifier that is unique within the provider system. Alternatively, the provider system might receive sufficient information to identify the merchant, and the provider system might look up location information to populate the transaction record. In some cases, transaction data might be received in record format, in which case creating a transaction record can comprise modifying such received records (e.g., by adding, deleting or changing data in one or more fields) and/or saving such received records in a local database, to name a couple of examples.

As noted above, the provider system might include and/or be in communication with one or more databases, and the merchant enrollment records, consumer enrollment records, and transaction records can be created and stored in one or more of these databases. A number of techniques can be used to create and/or store such records. For example an extract-transform-load (“ETL”) process can be used to populate a transaction database with transaction records, based on transaction data received in a batch process; as part of this process, any additional data manipulation (e.g., lookups on derived fields, acquisition of additional information necessary to populate each record, etc.) can be performed, and/or such manipulation can be performed later (e.g., as part of a scheduled process). With regard to the consumer and merchant enrollment records, the user interface provided to collect the enrollment information for those entities might be in communication with a back-end database management system that populates appropriate databases with the information supplied by the enrolling entities, and a separate process can be used to obtain any additional information necessary and populate the records accordingly. It should be noted that these examples are provided merely for purposes of illustration, and that a variety of techniques can be used to create and/or store database records from the information received by the provider system.

At block 535, the method 500 comprises obtaining real-time sales data for one or more merchants. The real-time sales data can be collected, e.g., using any of the transaction data collection techniques described above. In particular embodiments, real-time sales data is collected only for merchants that have enrolled in the offer matching service. For these merchants, specialized procedures can be used to collect real-time sales data. Merely by way of example, each merchant who enrolls in the service might configure its point-of-sale device to send transaction data to the provider system (either directly or through payment processor) at the time the merchant records the sale, such that sales data for enrolled merchants can be collected as it happens (i.e., in real-time), rather than as part of a batch process. Alternatively and/or additionally, the provider system might have an arrangement with a processor (based, e.g., on the identification of that processor in the merchant's transaction record) to immediately forward transaction records for that merchant as those records are created in the processor's system.

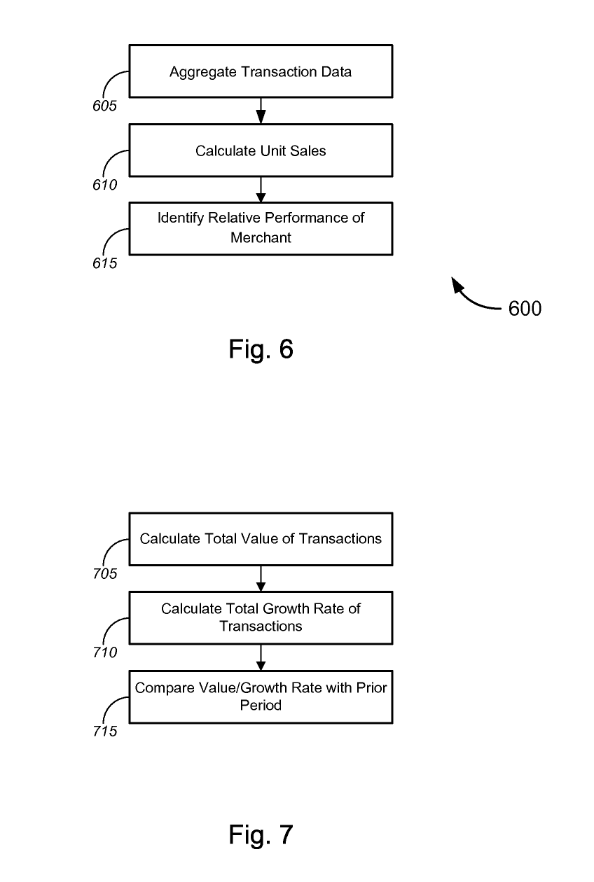

At block 540, the method 500 comprises determining that a particular merchant is underperforming (or, in some embodiments, overperforming). In some cases, this performance is judged in comparison with similar merchants in that merchant's geographical area. In a particular aspect of some embodiments, the determination of a merchant's under- or overperformance can be accomplished in real time, based at least in part on current sales data. There are a variety of techniques that can be used to determine whether a merchant is underperforming (or overperforming). FIG. 6, for example, illustrates a method 600 in accordance with some embodiments for making such a determination.

The method 600 includes aggregating transaction data for a plurality of merchants (block 605). In some cases, this transaction data can be aggregated over a desired time period (such as one or more days, weeks, months, years, etc.). Aggregating transaction data can comprise filtering the transaction records in the database by one or more criteria, such as a merchant category, a geographical area, and/or the specified time period, and collecting the records meeting the filter criteria into a group for analysis. In an aspect, this filtering operation can include even the most current records (which might correspond to transactions that happened within the same day, or even within the same hour or few minutes of the aggregation operation), so that the real-time analysis of the aggregated transaction data accounts for the most current data possible.

At block 610, the method 600 includes calculating unit sales for a group of merchants. In a particular aspect, the unit sales might be calculated for a group of merchants with the same (or similar) classification as the subject merchant, and/or merchants in the same (or similar) geographic area as the subject merchant, as defined by latitude/longitude coordinates within a particular radius of the merchant, ZIP code that is the same or similar as the merchant, addresses in the same neighborhood or within a specified radius or number of blocks of the merchant, etc. More generally, the unit sales can be calculated from the aggregated data records (which, as noted above, can be filtered to meet various criteria, such as similarity to the subject merchant (i.e., the merchant whose performance is being evaluated and/or for whom the offer matching service is being performed), such as the same classification and/or geographical area as the subject merchant, during the aggregation process.

There are several ways in which unit sales can be calculated, and FIG. 7 illustrates a few such techniques. In an aspect, any such calculation can be performed in real time using current and/or historical transaction data. In general, the technique of calculating unit sales allows the transactions of one or more “peers” of the subject merchant (i.e., merchants with the same or similar characteristics, which can include any combination of one or more factors such as merchant classification, products offered, average transaction amount, geographical area and/or the like) to be normalized for comparison against the current sales data of the subject merchant. The calculation of unit sales, then, can account for market-wide phenomena, such as economic conditions, weather, seasonal variation and/or the like, in order to allow an evaluation of the merchant's performance that does not consider variables that would correlate with the performance of both the merchant and its peers.

While FIG. 7 illustrates several techniques for calculating unit sales, these techniques can be applied alone or in combination, and other techniques can be used as well. Hence, the techniques illustrated by FIG. 7 should not be considered limiting but instead are provided for demonstrative purposes.

For example, in some cases, calculating unit sales can include calculating (perhaps in real time), a total value of retail payment transactions for merchants in the merchant's geographical area and/or classification (block 705). This calculation can be performed by summing the amounts of all of the aggregated transactions over the specified time period. This total value can be manipulated in other ways. For example, the total value can be divided by the number of transactions to produce a mean transaction value, which can serve as the unit sales for the selected group of merchants over the selected time period. Alternatively and/or additionally, the total value (or mean value) can be divided by the number of hours, days, weeks, and/or the like in the aggregation period, which can produce a unit sales per hour, day, week, etc., which can show how much the average merchant made in that amount of time.

Alternatively and/or additionally, calculating unit sales might comprise calculating a growth rate of the total value of such transactions (block 710). This growth rate can be calculated, for example, by summing the value of all of the aggregated transactions over a current period and summing the value of all of the aggregated transactions over a prior period, then subtracting the difference between the summed values from the current period and the summed values from the prior period, and then dividing this result by some values from the prior period. This calculation will produce a value that expresses the average growth (or decline) in sales for the merchant group from one period to the next. The choice of periods is discretionary and can depend on the desired nature of the analysis. For example, the current week's sales could be compared to sales from a prior week (or the same week of a prior year); alternatively, the current month could be compared to a prior month (or the same month of a prior year, etc.). Rather than merely showing the expected amount of sales for an average merchant in the category, this value can show how an average merchant could have expected its sales to grow or decline in the relevant period.

Still further, calculating unit sales might comprise comparing the total sales value (i.e., retail payment value) and/or growth rate with similar data from a prior period (block 715). In one aspect, this calculation can illustrate the growth of the growth rate for the average merchant in the selected group. In effect, this value can express the second derivative of the average transaction amount (i.e. sales) over time, which can be considered analogous to the “acceleration” of sales growth (or decline) over the specified time frame.

Any unit sales value (or combination of unit sales values), including without limitation those described above, can be used to evaluate the sales of the subject merchant to determine whether that merchant is performing to expectations, underperforming, or overperforming. Hence, returning to FIG. 6, once the unit sales have been calculated (using whatever technique is appropriate or desired), the method 600 comprises identifying the performance of the merchant relative to the unit sales (block 615). So, for example, the system might compare unit sales of the merchant with the unit sales of the geographic area/merchant classification the merchant falls into. Based on such a comparison, the system can determine whether the merchant is underperforming (i.e., that merchant's sales fall below the unit sales), that the merchant is overperforming (i.e., that the merchant's sales are above the unit sales), or that the merchant is performing as expected (i.e., that the merchant's sales are in equilibrium with the unit sales). In performing this evaluation, the system might employ thresholds (e.g., merchant sales within a certain threshold percentage or absolute value of the unit sales are considered performance as expected, while sales above a threshold percentage or amount of the unit sales are considered overperforming and sales below a threshold percentage within the unit sales are considered underperforming); the thresholds for overperformance and underperformance, respectively, can be the same magnitude (for example, five percent over or under the unit sales is considered performing as expected) or different.

Unit sales of the merchant can be calculated based on transaction records specific to the merchant, either using the same time periods as those of the aggregated merchant transactions or using a current period (such as the current day or the current week). Thus, for example, sales of the subject merchant over the past week could be compared to unit sales for the past week, calculated from all of the aggregated transactions. Similarly, sales growth and/or the change in sales growth over a particular period for the merchant can be compared with the corresponding or appropriate unit sales of the peer merchant group. In one aspect, the current sales data of the subject merchant can be used to make this comparison in real time, so that the comparison is as relevant as possible to the merchant's current sale performance.

By normalizing transaction data this way, a true performance of the merchant relative to its peers can be evaluated. Further, depending on the length of the period chosen, the evaluation can be as immediate or as long-ranging as desired. Thus, this evaluation can be performed in real time, using data ranging from up-to-the minute transactions to data that shows performance over the past week, month, year, or the like. In this way, among others, the systems provided by various embodiments provide an advance over conventional systems, because such embodiments can provide actionable evaluations, which do not rely merely on stale data, of merchants' performance. Such functionality is provided by the system's ability to perform data analytics on pertinent data in real time.

While the evaluation process is described above with respect to a single merchant, certain embodiments of the system can perform this process periodically and/or continually for each enrolled merchant in order to identify all underperforming or overperforming merchants enrolled in the service in real time (or within a reasonable time of the performance varying from expected performance).

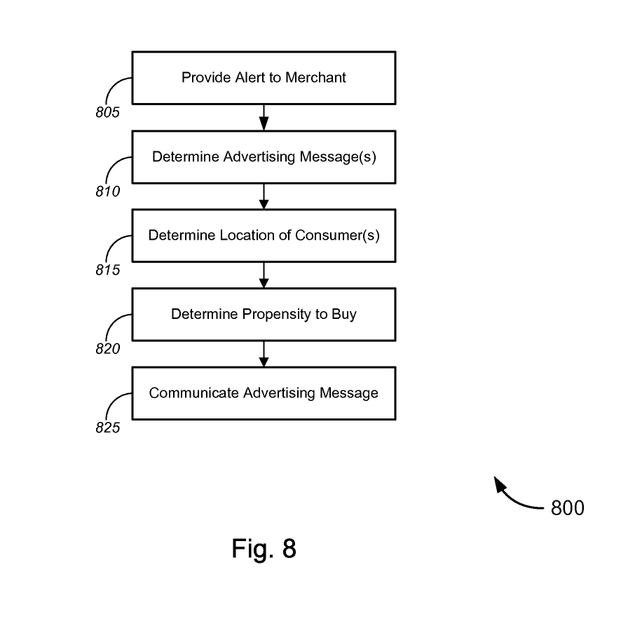

Once the performance of a merchant has been evaluated, the system can take action based on whether the merchant has been determined to be underperforming (or, in some cases, overperforming). For example, an underperforming merchant ideally would see an immediate sales increase to return that merchant at least to equilibrium with its peers and/or to meet specified performance thresholds. The real-time nature of the system enables such measures to be taken immediately, to correct performance imbalances as quickly as possible. FIG. 8, for example, illustrates a method 800 of developing and executing an advertising strategy to address determined underperformance.

At block 805, the method 800 includes providing an alert to the merchant indicating that the merchant has been determined to be underperforming. This alert can take many forms. Merely by way of example, the alert might be an email message sent to contact information on record with the provider (e.g. in the merchant enrollment record or another location). Alternatively and/or additionally, the provider system might send an SMS or other type of text message to a merchant contact and/or might place an automated voice call to a phone number associated with the merchant. As another example, the merchant might have a computer (or mobile device, point-of-sale device, etc.) running a software client provided by the provider, and the alert might be transmitted from the provider system to this client, which could display the alert for the merchant. A variety of contact methods are possible, and the system might use one or more such methods to alert the merchant in accordance with different environment.

In addition to notifying the merchant of its underperformance (or overperformance), the alert can contain other information as well. Merely by way of example, the system might make an initial determination of an amount of potential customers in the area of the merchant (e.g., using techniques similar to those described below). The alert message, then, might include an indication of the number of potential customers in the vicinity (e.g., as defined by a ZIP code of the merchant's location, a number of blocks or radius from the merchant's physical location, etc.) at the current time. Once again, this feature illustrates how the real-time nature of the offer matching service provided by various embodiments can provide a material advance over other systems.

As another example of additional information that can be provided by an alert, the alert message (or a follow up message) can provide the merchant with the option of implementing an advertising strategy to address this underperformance. For example, the alert might invite the merchant to log into the provider system to select among a plurality of advertising messages, including without limitation discount messages, offer messages, and/or advertisements, that can be sent to potential customers with a demonstrated propensity to buy the merchant's products. In some cases, the system might have preformatted messages (e.g., based on data input earlier by the merchant about products available, pricing, etc.) that offer differentiated pricing and/or discounts from the merchant's normal offerings and/or simply advertise the merchant's products. In other cases, the merchant can be given the option (e.g. through the user interface) to customize advertising messages and/or develop its own advertising messages. Hence, at block 810, the method 800 comprises determining one or more advertising messages to be sent to potential consumers; this determination can be made based on input from the merchant (as noted above) or might be made based on a selection from preformatted messages available from the provider without merchant input.

After determining the advertising message(s) to be sent to consumers that are potential customers of the merchant, the system can determine which consumer(s) are most likely to respond to the advertising message(s). As part of this technique, for example, the system can determine the locations of consumers that are potential customers of the merchant (block 815). In one aspect, each of the consumers might be an enrollee in the service, although this is not necessarily required. For instance, upon enrolling in the service, a consumer might install an application on a mobile device, and that application might be configured to collect location data (e.g., using any of a variety of techniques available to mobile devices, such as base station triangulation, a global navigation satellite system (“GNSS”) receiver built into a mobile device, and/or the like) and transmit it to the provider server, e.g., periodically, on request by the server, on request by the consumer, etc. Alternatively and/or additionally, the service provider might have access to such data itself (for example, if the service provider is also a telecommunication provider for a consumer or has an agreement with such a telecommunication provider), based on the consent of the consumer. In some cases, the provider might have access to vehicle location data of the consumer's vehicle (again, perhaps with the consent of the consumer), e.g., from a vehicle service provider such as OnStar™. As another example, the provider server might determine the location of a consumer based on that consumer's use of a registered payment card (for example, by determining the location of a merchant with whom the customer has just engaged in a transaction, the data of which can be obtained by the provider server in any manner described above).

At block 820, the method 800 includes determining a propensity of one or more of the identified consumers to buy products from the merchant. This propensity can be determined from the current location of a consumer, from a vector of movement of the consumer (e.g., toward or away from the merchant's physical location), and/or historical transaction data about the consumer's past transactions. The consumer's past transactions can be analyzed to evaluate whether the consumer has purchased products from the merchant in the past (and/or how recently the consumer has purchased such products), whether the consumer has purchased products from the merchant's peers, and/or whether the consumer has purchased products with a stock keeping unit (“SKU”) indicating those purchased products are similar to those sold by the merchant, to name a few examples.

The location, vector of movement, and/or purchase history of a consumer can be used to determine a propensity of the consumer to purchase products from the merchant. For instance, a consumer with a history of purchasing the type of products sold by the merchant might be considered likely (relative to other consumers) to buy products from merchants. A consumer who has purchased products from the merchant itself might be considered relatively even more likely to purchase products from the merchant. As another dimension of the analysis, a consumer relatively near the merchant's physical location might be considered relatively more likely to purchase products from the merchant, and/or a consumer with the movement vector toward the merchant's physical location might be considered relatively more likely to purchase products from merchant.

Each of these dimensions (and others, if desired) can be considered by the provider system in determining a propensity of a particular consumer to buy products from the merchant. Thus, for example, a consumer who has purchased products from merchants similar to the subject merchant and/or who has purchased products similar to those sold by the subject merchant, who is within a particular distance of the subject merchant physical location (e.g., within a half-mile, within three blocks, etc.) and who has a vector of movement toward the merchant's physical location might be considered to have a high propensity to buy products from the merchant.

It should be noted that such determinations of consumer propensity, and/or relatively simpler determination of propensity, such as a determination that takes into account only location and user movement vector, can be performed before sending an alert to the merchant, such that the alert can include an indication of the number of potential consumers with at least some propensity to buy products from the merchant, which can encourage the merchant to engage in the offer matching process. For example, the alert might indicate the number of customers within a particular radius (e.g. ½ mile) that would appear to have a propensity and/or have a demonstrated propensity to buy products from the merchant and/or to buy products similar to those sold by the merchant.

Once high propensity consumers have been identified, the method 800 can include communicating one or more advertising messages (e.g., the advertising messages determined in the fashion described above) can be transmitted to each of the consumers. As noted above, a variety of techniques can be used to transmit messages to consumers, including email, SMS and/or text messaging, messages provided to an application for mobile device, and/or the like. In some cases, messages can be customized for particular consumer; for example a message might indicate awareness that a particular consumer has purchased products from that merchant before and/or might compare the products purchased by the consumer from other merchants in the past.

Such messages can be sent in a number of different ways. For example, in some cases the provider system might generate and transmit the messages itself. In other cases, the provider system might generate a list of addresses (or other contact information) and provide those addresses and/or the messages to be sent to the merchant's computer system, perhaps to a client application of the provider system installed on the merchant's local computer, so that the merchant can send the messages directly to the consumers. In an aspect, any facilitation of the message transmission (and/or direct transmission of the messages) by the provider system can be considered to be communication by the provider system to the consumers. Thus, for example, the provider system could be considered to communicate messages to consumers if it provided those consumers' contact information (e.g., phone numbers, email addresses, etc.) to a merchant computer system, either through a client application or otherwise.

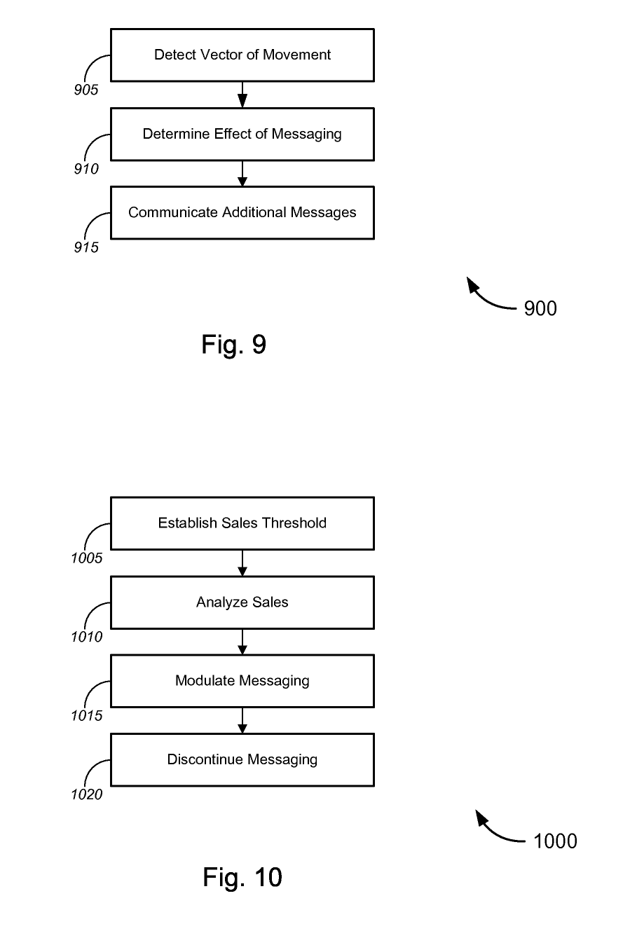

The system can send any number of messages to any number of consumers. For example, the system might send multiple messages to particular consumers over any desired time frame. The communication of messages also can vary over time, based on various factors. Merely by way of example, certain embodiments can employ feedback techniques to fine tune or adjust the communication. FIGS. 9 and 10 illustrate two examples of such feedback techniques that can be used separately and/or together, in accordance with various embodiments.

FIG. 9, for example, illustrates a method 900 in which the perceived reaction of the consumer to advertising messaging is used to adjust future messages. According to the method 900, the system detects a vector of movement of a consumer to whom one or more advertising messages have been communicated (block 905). The vector of the consumer's movement can be determined based on progressive determination of the consumer's position over time (for example, using the location determination techniques described above). At block 910, the method 900 comprises determining the effect of the dedicated advertising messages. For example, if, after receiving an advertising message, the consumer's vector of movement begins to approximate the physical location of the merchant, the system might determine that the advertising message has had a positive effect on the consumer's propensity to purchase products from the merchant. Conversely, if the movement vector of the consumer tends away from the merchant's physical location, the system might determine that the advertising message has not had a positive effect on consumers and city to purchase products from the merchant.

Based on the determined effect of the advertising messages, the system might communicate additional messages to the consumer (block 915). For example, if the system determines that prior messages have had a positive effect on the consumer's propensity, the system may transmit additional messages further encouraging the consumer to visit the merchant including without limitation directions to the merchant's physical location, additional details about products that the consumer can purchase, and/or the like. On the other hand, if the system determines the prior messages have not had a positive effect on the consumer's propensity, the system might send additional messages with different content, such as more aggressive offers or discounts, advertisements of different products offered by the merchant, and/or the like.

FIG. 10 illustrates a method 1000 illustrating another type of feedback technique that can be used in accordance with various embodiments. The method 1000 includes establishing a sales threshold for the subject merchant (block 10005). The sales threshold can be expressed in thy number of different ways; for example, the sales threshold might be an absolute amount of sales over certain period (such as an hour, day, week, etc.). Alternatively or additionally, the sales threshold might be relative, with respect to past sales of the merchant, unit sales of peer merchants, and/or the like. Thus for example, threshold might be sales of $10,000 within a day of initiating the advertising strategy. As another example, the threshold might be equilibrium (to within a specified precision, amount, or percentage, such as $1000 or 1%) with similar merchants (e.g., merchants of the same classification in the same geographical area). A further example of the sales threshold might be sales growth of 40% over the prior week's sales. From these examples, the skilled reader can appreciate that any number of thresholds can be used, and that the determination of a particular threshold can be flexible and/or tailored to the merchant's particular business. In one aspect, the merchant itself can set the threshold; in other cases, the provider system might set the threshold automatically based on evaluation of the merchants pass sales and/or sales of peer merchants.

At block 1010, the method 1000 comprises analyzing sales of the merchant after the advertising strategy has been implemented. For example, the number and/or type of advertising messages sent might be compared an increase in the volume of a merchant's sales, and/or the sales volume can be compared with the specified threshold. The number and/or type of messages communicated can then be modulated (block 1015) in response to the changes in sales volume (for example, to modify messaging that appears not to positively affect sales volume and/or to increase messaging that appears to positively affect sales volume). Further, the advertising messages might comprise a mix of offer messages, discount messages, and/or advertisements, or mixes of different types of offers and/or discounts. The response to these different types of messages can be tracked, for example by analyzing transaction data from the merchant and correlating transactions with consumers who have received different types of messages. Based on this correlation, the effectiveness of different messages can be evaluated; for example, many consumers who received a particular offer might have purchase the offered product, while no consumers who received different offer might've purchased the effort product. In such case, the messaging may be modulated to communicate more of the relatively more effective offers to different consumers.

In a particular aspect, the type and/or number of the messages communicated can be modulated as the sales volume approaches the specified threshold. Thus for example, as a merchant's sales increase toward the specified threshold, the number of advertising messages sent might be decreased, the aggressiveness of offers/discounts specified in the messages might be reduced, and/or offer/discount messages might be replaced with mere advertisements. To that end, at block 1020, when sales volume has reached the specified threshold, the method 1000 might discontinue the advertising strategy (i.e. discontinue transmission of advertising messages).

FIG. 11 provides a schematic illustration of one embodiment of a computer system 1100 that can perform the methods provided by various other embodiments, as described herein, and/or can function as a consumer device, a point-of sale device, a merchant system, a provider system, and/or the like. It should be noted that FIG. 11 is meant only to provide a generalized illustration of various components, of which one or more (or none) of each may be utilized as appropriate. FIG. 11, therefore, broadly illustrates how individual system elements may be implemented in a relatively separated or relatively more integrated manner.

The computer system 1100 is shown comprising hardware elements that can be electrically coupled via a bus 1105 (or may otherwise be in communication, as appropriate). The hardware elements may include one or more processors 1110, including without limitation one or more general-purpose processors and/or one or more special-purpose processors (such as digital signal processing chips, graphics acceleration processors, and/or the like); one or more input devices 1115, which can include without limitation a mouse, a keyboard and/or the like; and one or more output devices 1120, which can include without limitation a display device, a printer and/or the like.

The computer system 1100 may further include (and/or be in communication with) one or more storage devices 1125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1100 might also include a communications subsystem 1130, which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 1130 may permit data to be exchanged with a network (such as the network described below, to name one example), with other computer systems, and/or with any other devices described herein. In many embodiments, the computer system 1100 will further comprise a working memory 1135, which can include a RAM or ROM device, as described above.

The computer system 1100 also may comprise software elements, shown as being currently located within the working memory 1135, including an operating system 1140, device drivers, executable libraries, and/or other code, such as one or more application programs 1145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 1125 described above. In some cases, the storage medium might be incorporated within a computer system, such as the system 1100. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 1100 and/or might take the form of source and/or installable code, which, upon compilation and/or installation on the computer system 1100 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1100) to perform methods in accordance with various embodiments of the invention. According to a set of embodiments, some or all of the procedures of such methods are performed by the computer system 1100 in response to processor 1110 executing one or more sequences of one or more instructions (which might be incorporated into the operating system 1140 and/or other code, such as an application program 1145) contained in the working memory 1135. Such instructions may be read into the working memory 1135 from another computer readable medium, such as one or more of the storage device(s) 1125. Merely by way of example, execution of the sequences of instructions contained in the working memory 1135 might cause the processor(s) 1110 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 1100, various computer readable media might be involved in providing instructions/code to processor(s) 1110 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 1125. Volatile media includes, without limitation, dynamic memory, such as the working memory 1135. Transmission media includes, without limitation, coaxial cables, copper wire and fiber optics, including the wires that comprise the bus 1105, as well as the various components of the communication subsystem 1130 (and/or the media by which the communications subsystem 1130 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 1110 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1100. These signals, which might be in the form of electromagnetic signals, acoustic signals, optical signals and/or the like, are all examples of carrier waves on which instructions can be encoded, in accordance with various embodiments of the invention.

The communications subsystem 1130 (and/or components thereof) generally will receive the signals, and the bus 1105 then might carry the signals (and/or the data, instructions, etc. carried by the signals) to the working memory 1135, from which the processor(s) 1105 retrieves and executes the instructions. The instructions received by the working memory 1135 may optionally be stored on a storage device 1125 either before or after execution by the processor(s) 1110.

As noted above, a set of embodiments comprises systems for providing offer-matching services. FIG. 12 illustrates a schematic diagram of a system 1200 that can be used in accordance with one set of embodiments. The system 1200 can include one or more user computers 1205, which can be embodied by consumer devices, merchant computers, point-of-sale devices, and/or the like. A user computer 1205 can be a general purpose personal computer (including, merely by way of example, desktop computers, tablet computers, phones or other mobile devices, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer 1205 can also have any of a variety of applications, including one or more applications configured to perform methods provided by various embodiments (as described above, for example) such as a client application for the offer matching service, as well as one or more office applications, database client and/or server applications, and/or web browser applications. Alternatively, a user computer 1205 can be any other electronic device, such as a thin-client computer, Internet-enabled mobile telephone, and/or personal digital assistant, capable of communicating via a network (e.g., the network 1210 described below) and/or of displaying and navigating web pages or other types of electronic documents. Although the exemplary system 1200 is shown with three user computers 1205, any number of user computers can be supported.

Certain embodiments operate in a networked environment, which can include a network 1210. The network 1210 can be any type of network familiar to those skilled in the art that can support data communications using any of a variety of commercially-available (and/or free or proprietary) protocols, including without limitation TCP/IP and the like. Merely by way of example, the network 1210 can include a local area network (“LAN”), including without limitation a fiber network, an Ethernet network, a Token-Ring™ network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 1215. Each of the server computers 1215 may be configured with an operating system, including without limitation any of those discussed above, as well as any commercially (or freely) available server operating systems. Each of the servers 1215 may also be running one or more applications, which can be configured to provide services to one or more clients 1205 and/or other servers 1215. For example, one or more servers 1215 can operate applications to act as a provider system, a transaction processor, a merchant computer system, and/or the like.

In some embodiments, one of the servers 1215 may be a web server, which can be used, merely by way of example, to process requests for web pages or other electronic documents from user computers 1205. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 1205 to perform methods of the invention.

The server computers 1215, in some embodiments, might include one or more application servers, which can be configured with one or more applications accessible by a client running on one or more of the client computers 1205 and/or other servers 1215. Merely by way of example, the server(s) 1215 can be one or more general purpose computers capable of executing programs or scripts in response to the user computers 1205 and/or other servers 1215, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™, IBM™ and the like, which can process requests from clients (including, depending on the configuration, dedicated database clients, API clients, web browsers, etc.) running on a user computer 1205 and/or another server 1215. In some embodiments, an application server can create web pages dynamically for displaying the information in accordance with various embodiments, such as for providing a web page for receiving enrollment information, for interacting with a merchant to implement and advertising strategy, and/or the like Data provided by an application server may be formatted as one or more web pages (comprising HTML, JavaScript, etc., for example) and/or may be forwarded to a user computer 1205 via a web server (as described above, for example). Similarly, a web server might receive web page requests and/or input data from a user computer 1205 and/or forward the web page requests and/or input data to an application server. In some cases a web server may be integrated with an application server.

In accordance with further embodiments, one or more servers 1215 can function as a file server and/or can include one or more of the files (e.g., application code, data files, etc.) necessary to implement various disclosed methods, incorporated by an application running on a user computer 1205 and/or another server 1215. Alternatively, as those skilled in the art will appreciate, a file server can include all necessary files, allowing such an application to be invoked remotely by a user computer 1205 and/or server 1215.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 1220, which can store data as indicated above. The location of the database(s) 1220 is discretionary: merely by way of example, a database 1220a might reside on a storage medium local to (and/or resident in) a server 1215a (and/or a user computer 1205). Alternatively, a database 1220b can be remote from any or all of the computers 1205, 1215, so long as it can be in communication (e.g., via the network 1210) with one or more of these. In a particular set of embodiments, a database 1220 can reside in a storage-area network (“SAN”) familiar to those skilled in the art. (Likewise, any necessary files for performing the functions attributed to the computers 1205, 1215 can be stored locally on the respective computer and/or remotely, as appropriate.) In one set of embodiments, the database 1220 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. A method, comprising:
creating, in a database, a merchant enrollment record for a merchant based on a request from the merchant to enroll in a service, the merchant enrollment record comprising a physical sales location of the merchant, an identifier of the merchant, a classification of the merchant, an average transaction value of purchases from the merchant, opening and closing hours of the merchant, and an identifier of a payment processor of the merchant;
creating, in the database, consumer enrollment records for a plurality of consumers, based on a request from each of the plurality of consumers to enroll in the service, each consumer enrollment record comprising payment card information, contact information, and geolocation information;
storing, in the database, transaction data of each of the plurality of consumers;
obtaining, with a computer, real-time sales data of the merchant, based on the identifier of the payment processor of the merchant;
aggregating, with the computer, transaction data over a specified period for a plurality of merchants;
calculating, with the computer and from the aggregated transaction data, unit sales for a geographical area of the merchant and the classification of the merchant;
identifying, with the computer and in real time, current performance of the merchant relative to the unit; sales, based at least in part on the real-time sales data of the merchant;
determining, in real time and with the computer, that the merchant is underperforming compared to similar merchants in the geographical area, based at least in part on the real-time sales data;
determining, with the computer, a propensity of each of one or more consumers to buy products from the merchant, based at least in part on a current location of each of the one or more consumers and historical transaction data of each of the one or more customers;
providing, with the computer, an alert to the merchant, the alert indicating that the merchant is underperforming, the alert identifying a number of potential customers within a specified perimeter of the physical sales location of the merchant with a demonstrated propensity to buy products from providers within the classification of the merchant;
communicating, from the computer and to each of the one or more consumers with a determined propensity to buy products from the merchant, an advertising message comprising an offer to buy one or more products from the merchant;
detecting, with the computer, a vector of movement of one of the consumers to whom the offer was communicated;
based on a determination that the vector of movement is approaching the physical sales location of the merchant, communicating one or more additional advertising messages to the one of the consumers;
comparing, with the computer, a number and type of transmitted advertising messages with an increase in volume of sales of the merchant; and
modulating, with the computer, a number and type of advertising messages transmitted to the one or more customers until performance of the merchant reaches equilibrium, to within a specified precision, with the unit sales for the geographical area of the merchant and the classification of the merchant; and
discontinuing, with the computer, transmission of advertising messages when the performance of the merchant reaches equilibrium, to within the specified precision, with the unit sales for the geographical area of the merchant and the classification of the merchant.

2. A method, comprising:
creating, in a database, a merchant enrollment record for a merchant;
creating, in the database, consumer enrollment records for a plurality of consumers;
storing, in the database, transaction data of each of the plurality of consumers;
obtaining, with a computer, real-time sales data of the merchant;
determining, with the computer and in real time, that the merchant is underperforming compared to similar merchants in the geographical area, based at least in part on the real-time sales data of the merchant;
determining, in real time and with the computer, a propensity of each of one or more consumers to buy products from the merchant, based at least in part on a current location of each of the one or more consumers and historical transaction data of each of the one or more customers; and
communicating, to each of to each of the one or more consumers with a determined propensity to buy products from the merchant, an advertising message comprising an offer to buy one or more products from the merchant.

3. The method of claim 2, wherein the merchant enrollment record comprises a physical sales location of the merchant, an identifier of the merchant, a classification of the merchant, an average transaction value of purchases from the merchant, opening and closing hours of the merchant, and an identifier of a payment processor of the merchant.

4. The method of claim 3, wherein the classification of the merchant comprises a Standard Industrial Classification (“SIC”) code assigned to the merchant.

5. The method of claim 3, wherein the classification of the merchant comprises a free text description of a type of the merchant.

6. The method of claim 2, wherein each consumer enrollment record comprises payment card information, contact information, and geolocation information.

7. The method of claim 6, wherein the contact information includes one or more values selected from a group consisting of a wireless phone number, an email address, and a user identifier in a mobile application.

8. The method of claim 6, wherein the geolocation information comprises one or more values selected from the group consisting of a wireless phone number, a car registration, an Internet Protocol address, and a Media Access Control (“MAC”) address.

9. The method of claim 8, further comprising:
determining a current location of each of the one or more consumers, by obtaining global navigation satellite system (“GNSS”) data based on the geolocation information.

10. The method of claim 2, wherein determining that the merchant is underperforming comprises:
aggregating, with the computer, transaction data over a specified period;
calculating, with the computer and from the aggregated transaction data, unit sales for a geographical area of the merchant and a classification of the merchant; and
identifying, with the computer, performance of the merchant relative to the unit sales.

11. The method of claim 10, wherein calculating unit sales comprises calculating, in real time, a total value of retail payment transactions for the geographical area.

12. The method of claim 11, wherein calculating unit sales comprises calculating, in real time, a total growth rate of retail payment transactions for the geographical area.

13. The method of claim 10, wherein the time period is selected from a group consisting of one or more days, one or more weeks, one or more months, or one or more years.

14. The method of claim 10, wherein calculating unit sales comprises comparing a total of value of retail payment transactions for a current period with a total value of retail payment transactions for a prior period.

15. The method of claim 10, wherein the geographic area comprises an area defined by a radius from a physical sales location of the merchant, an area defined by a ZIP code of a physical location of the merchant, or both.

16. The method of claim 2, wherein the transaction data comprises a physical location of each transaction, and wherein a determination of the propensity of each of one or more consumers to buy products from the merchant is based at least in part on the current location of each of the one or more customers and historical transaction data, including data about the location of each transaction, of each of the one or more customers.

17. The method of claim 2, further comprising:
providing, with the computer, an alert to the merchant, the alert indicating that the merchant is underperforming, the alert identifying a number of potential customers within a specified perimeter of the physical sales location of the merchant with a demonstrated propensity to buy goods from providers within the classification of the merchant.

18. The method of claim 2, further comprising:
detecting, with the computer, a vector of movement in one of the consumers to whom the offer was communicated; and
based on the vector of movement, communicating one or more additional advertising messages to the one of the consumers.

19. The method of claim 2, further comprising:
comparing, with the computer, a number and type of transmitted advertising messages with an increase in volume of sales of the merchant.

20. The method of claim 2, further comprising:
modulating, with the computer, a number and type of advertising messages transmitted to the one or more customers until performance of the merchant reaches a determined threshold.

21. The method of claim 20, wherein the determined threshold comprises an equilibrium between performance of the merchant and performance of similar merchants.

22. The method of claim 20, wherein the determined threshold comprises an amount of sales.

23. The method of claim 2, further comprising:
discontinuing, with the computer, transmission of advertising messages when the performance of the merchant reaches a determined threshold.

24. The method of claim 2, wherein communicating an advertising message comprises transmitting an advertising message by electronic mail or text message.

25. The method of claim 2, wherein communicating an advertising message comprises communicating an advertising message through a mobile application on a wireless device of a user.

26. The method of claim 2, further comprising:
receiving merchant enrollment information from the merchant via a telephone call, web site, or mobile application.

27. The method of claim 2, further comprising:
receiving a consumer enrollment request from one or more of the plurality of consumers via a telephone call, web site, or mobile application.

28. The method of claim 2, further comprising:
receiving consumer enrollment data from a card issuer of payment cards issued to one or more of the plurality of customers.

29. An apparatus, comprising:
a non-transitory computer readable medium having encoded thereon a set of instructions executable by one or more computers to perform one or more operations, the set of instructions comprising:
instructions to create, in a database, a merchant enrollment record for a merchant;
instructions to create, in the database, consumer enrollment records for a plurality of consumers;
instructions to store, in the database, transaction data of each of the plurality of consumers;
instructions to obtain real-time sales data of the merchant;
instructions to determine, in real-time that the merchant is underperforming compared to similar merchants in the geographical area, based at least in part on the real-time sales data;
instructions to determine, in real time, a propensity of each of one or more consumers to buy products from the merchant, based at least in part on a current location of each of the one or more consumers and historical transaction data of each of the one or more customers; and
instructions to communicate, to each of the one or more consumers with a determined propensity to buy products from the merchant, an advertising message comprising an offer to buy one or more products from the merchant.

30. A computer system, comprising:
one or more processors; and
a computer readable medium in communication with the one or more processors, the computer readable medium having encoded thereon a set of instructions executable by the one or more processors to perform one or more operations, the set of instructions comprising:
instructions to create, in a database, a merchant enrollment record for a merchant;
instructions to create, in the database, consumer enrollment records for a plurality of consumers;
instructions to store, in the database, transaction data of each of the plurality of consumers;
instructions to obtain real-time sales data of the merchant;
instructions to determine, in real-time, that the merchant is underperforming compared to similar merchants in the geographical area, based at least in part on the real-time sales data of the merchant;
instructions to determine, in real time, a propensity of each of one or more consumers to buy products from the merchant, based at least in part on a current location of each of the one or more consumers and historical transaction data of each of the one or more customers; and
instructions to communicate, to each of the one or more consumers with a determined propensity to buy products from the merchant, an advertising message comprising an offer to buy one or more products from the merchant.
